(19) United States
(12) Patent Application Publication
(10) Pub. No.: US 2026/0323136 A1
(43) Pub. Date: Oct. 15, 2026

(54) MULTIMEDIA GENERATION APPARATUS AND METHOD

(71) Applicant: INSTITUTE FOR INFORMATION INDUSTRY, TAIPEI (TW)

(72) Inventors: Min DI, Taipei (TW); Bo Chih CHEN, Taipei (TW); Ming Fang WENG, Taipei (TW)

(21) Appl. No.: 19/226,187

(22) Filed: Jun. 3, 2025

(30) Foreign Application Priority Data
Apr. 15, 2025 (TW) 114114235

(51) Int. Cl. H04N 21/854; G06T 11/00; H04N 21/81; H04N 21/84; H04N 21/845

(52) U.S. Cl. CPC H04N 21/854; G06T 11/00; H04N 21/8113; H04N 21/816; H04N 21/84; H04N 21/8456

(57) ABSTRACT

A multimedia generation apparatus and method are provided. The apparatus utilizes a language model to generate a plurality of scene descriptions, a plurality of dialogue texts, and a music description that correspond to a storyline based on a prompt text. The apparatus generates a plurality of dialogue audios based on the dialogue texts. The apparatus generates a plurality of 360-degree images based on the scene descriptions. The apparatus generates a plurality of 360-degree videos based on the 360-degree images. The apparatus generates a background music based on the music description. The apparatus combines the dialogue audios, the 360-degree videos, and the background music to output a multimedia file that corresponds to the storyline.

### CROSS-REFERENCE TO RELATED APPLICATION

This application claims priority to Taiwan Application Serial Number 114114235, filed Apr. 15, 2025, which is herein incorporated by reference in its entirety.

### BACKGROUND

### Field of Invention

The disclosure relates to a multimedia generation apparatus and a method. More particularly, the disclosure relates to a multimedia generation apparatus and a method related to a 360-degree video.

### Description of Related Art

In existing technologies, video production requires manually written scripts. In addition to the storyline, the scripts also must include detailed content such as scenes, dialogues, narration, music, and more, to generate media elements such as images, videos, audio, music, and subtitles, which are then combined to generate a multimedia file.

In addition, with the popularization of extended reality (XR) technology, the application of 360-degree videos is also on the rise.

In view of this, how to provide a more convenient multimedia generation technology that can be applied to extended reality has become a pressing goal for the industry to pursue.

### SUMMARY

To order to solve the above problem, the disclosure provides a multimedia generation apparatus that includes a storage and a processor. The processor is electrically connected to the storage, and is configured to perform operations of: based on a prompt text, utilizing a first language model to generate a plurality of scene descriptions, a plurality of dialogue texts, and a music description that correspond to a storyline, based on the dialogue texts, generating a plurality of dialogue audios that correspond to the dialogue texts, based on the scene descriptions, utilizing a text-to-image model to generate a plurality of 360-degree images that correspond to the scene descriptions, based on the 360-degree images, utilizing an image-to-video model to generate a plurality of 360-degree videos that correspond to the 360-degree images, based on the music description, utilizing a text-to-audio model to generate a background music that corresponds to the music description, and combining the dialogue audios, the 360-degree videos, and the background music to store a multimedia file that corresponds to the storyline in the storage.

The disclosure further provides a multimedia generation apparatus that is applied to an electronic device and that includes steps of: based on a prompt text, utilizing a first language model to generate a plurality of scene descriptions, a plurality of dialogue texts, and a music description that correspond to a storyline, based on the dialogue texts, generating a plurality of dialogue audios that correspond to the dialogue texts, based on the scene descriptions, utilizing a text-to-image model to generate a plurality of 360-degree images that correspond to the scene descriptions, based on the 360-degree images, utilizing an image-to-video model to generate a plurality of 360-degree videos that correspond to the 360-degree images, based on the music description, utilizing a text-to-audio model to generate a background music that corresponds to the music description, and combining the dialogue audios, the 360-degree videos, and the background music to output a multimedia file that corresponds to the storyline.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows.

FIG. 1 is a schematic diagram illustrating a multimedia generation apparatus according to a first embodiment of the disclosure.

FIG. 2 is a schematic diagram illustrating operations of the multimedia generation apparatus for generating a multimedia file according to some embodiments of the present disclosure.

FIG. 3 is a schematic diagram of generating a plurality of 360-degree video segments according to some embodiments of the disclosure.

FIG. 4 is a flow chart illustrates a multimedia generation method according to a second embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

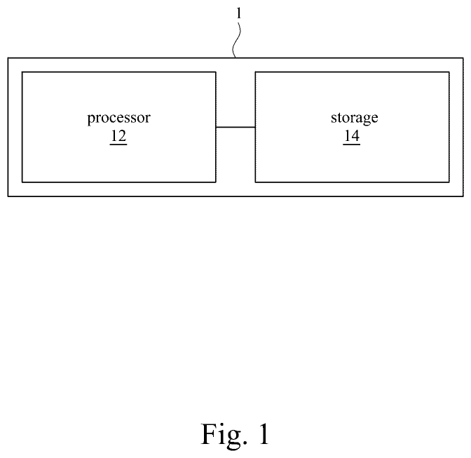

Referring to FIG. 1, FIG. 1 is a schematic diagram illustrating a multimedia generation apparatus 1 according to a first embodiment of the disclosure. The multimedia generation apparatus 1 includes a processor 12 and a storage 14, the processor 12 is electrically connected to the storage 14. The multimedia generation apparatus 1 is configured to generate a multimedia file a 360-degree video.

In some embodiments, the processor 12 may include central processing units (CPU), graphics processing units (GPU), multiprocessors, distributed processing systems, application specific integrated circuits (ASIC), and/or suitable computing units.

In some embodiments, the storage 14 may include semiconductor or solid-state memory, magnetic tapes, removable computer disks, random access memory (RAM), read-only memory (ROM), a hard disk, and/or optical disks.

The multimedia generation apparatus 1 may generate a multimedia file including a 360-degree video, a dialogue audio, and a background music based on a prompt text.

Specifically, the processor 12 is configured to perform the following operations: based on the prompt text, utilizing a first language model to generate a scene description, a dialogue text, and a music description corresponding to the storyline, based on the dialogue text, generating the dialogue audio corresponding to the dialogue text, based on the scene description, utilizing a text-to-image model to generate a 360-degree image corresponding to the scene description, based on the 360-degree image, utilizing an image-to-video to generate the 360-degree video corresponding to the 360-degree image, based on the music description, utilizing a text-to-audio model to generate the background music corresponding to the music description, and combining the dialogue audio, the 360-degree videos, and the background music to store the multimedia file corresponding to the storyline to the storage 14.

First, the multimedia generation apparatus 1 expands the prompt text based on the first language model to generate a plurality of scenes of the story, descriptions of each scene, character dialogue content, and a description of background music.

Prompt text is a prompt for the storyline and may be obtained by the multimedia generation apparatus 1 from text input by a user, a web crawler, data pre-stored in the storage 14, and/or other means. In some embodiments, the multimedia generation apparatus 1 receives a story title input by the user, and generates the prompt text in combination with a predefined template, such as shown in Table 1 below.

TABLE 1
Please help me create a fairy tale titled {story_title}. This story should be
divided into multiple scenes, and you may freely design character
dialogue.
For each scene, please design an illustration. However, for the illustration,
you do not need to generate an image directly, just provide a scene
description suitable for a text-to-image model.
For each scene, please also design suitable background music. You do not
need to generate background music directly, just provide a music
description suitable for a text-to-music model.
When you respond, please follow the format below:
[Scene Title 1]:
[Scene Description 1]:
[Music Description 1]:
[Character - Character Name A]:
[Character - Character Name B]:

The multimedia generation apparatus 1 receives the story title input by the user, replaces {story_title} in the prompt text with the story title and inputs the prompt text into a language model. Accordingly, the language model correspondingly generates the scene description, the music description, and the dialogue text for scenes.

After generating the dialogue text, the multimedia generation apparatus 1 converts the dialogue text into the dialogue audio, the dialogue audio includes an audio file that the content of the dialogue text is converted into spoken dialogues.

In some embodiments, the multimedia generation apparatus 1 inputs the dialogue text into a text-to-speech model to generate the dialogue audio.

After generating the scene description, the multimedia generation apparatus 1 utilizes a text-to-image model to generate the static 360-degree image based on the scene description, which serves as material for the subsequent generation of the 360-degree video.

Furthermore, the multimedia generation apparatus 1 utilizes an image-to-video model to generate the dynamic 360-degree video based on the 360-degree image.

On the other hand, the multimedia generation apparatus 1 also utilizes a text-to-audio model to generate the background music based on the music description.

Finally, the multimedia generation apparatus 1 combines the dialogue audio, the 360-degree video and the background music to output the multimedia file having dynamic images, character dialogue and background music, and stores the multimedia file in the storage 14.

Accordingly, the multimedia generation apparatus 1 may expand the prompt text such as the story title into the multimedia file having 360-degree video, character dialogue and background music.

In some embodiments, when utilizing a language model to generate the scene description, the multimedia generation apparatus 1 may also specify a scene quantity. Specifically, the operation of the processor 12 to generate the scene description further includes: inputting the prompt text and the scene quantity into the first language model to output the scene description, wherein the number of the scene description matches the scene quantity.

In Table 1, for example, the multimedia generation apparatus 1 receives the story title and the scene quantity input by the user, and adds a prompt “This story needs to be divided into {n} scenes” in the prompt text, wherein {n} may be replaced by the scene quantity. Accordingly, the multimedia generation apparatus 1 may generate the scene description including the specified scene quantity.

In some embodiments, the multimedia generation apparatus 1 may also instruct the language model to generate narration for the story. Specifically, the processor 12 is further configured to perform the following operations: based on the prompt text, utilizing the first language model to generate a narration text corresponding to the storyline, based on the narration text, generating a narration audio corresponding to the narration text, and combining the dialogue audio, the 360-degree video, the background music, and the narration audio to output the multimedia file.

In Table 1, for example, when generating the scene description, the dialogue text, and the music description, the multimedia generation apparatus 1 may add prompts “Each scene will have character dialogue or narration. You may freely design character dialogue and narration, and each scene must have at least one of character dialogue and narration” and “When you respond, please follow the format below: [Character-Narration]:”. Accordingly, the multimedia generation apparatus 1 may utilize the language model to generate the narration text.

Furthermore, similar to generating the dialogue audio, the multimedia generation apparatus 1 inputs the narration text into a text-to-speech model to generate the narration audio. Finally, the multimedia generation apparatus 1 combines the dialogue audio, the 360-degree video, the background music, and the narration audio to output the multimedia file.

In some embodiments, the multimedia generation apparatus 1 also generates a subtitle based on the dialogue text and the narration text and adds the subtitle into the multimedia file.

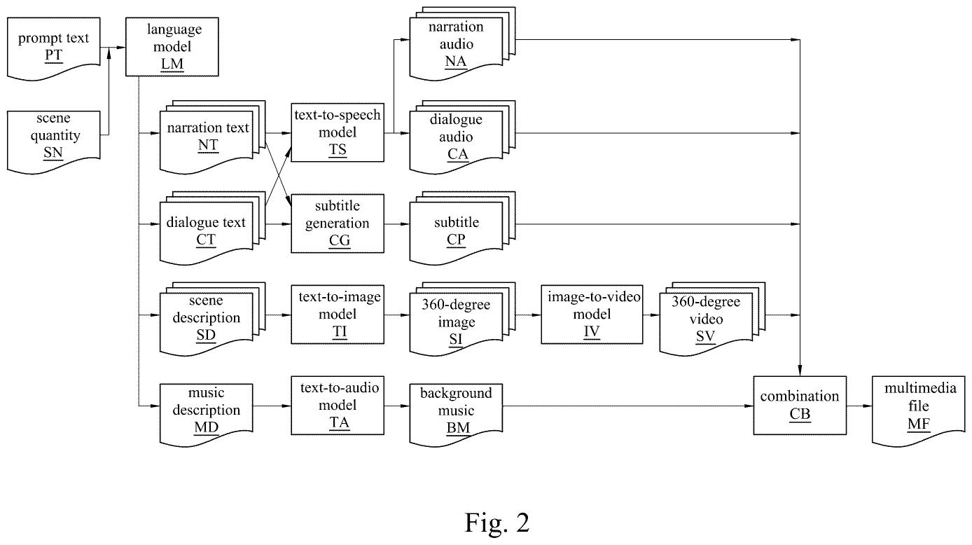

For the sake of illustration, please further refer to FIG. 2, which is a schematic diagram of operations of the multimedia generation apparatus 1 for generating a multimedia file MF according to some embodiments of the disclosure.

First, after inputting a prompt text PT (as shown in Table 1) and a scene quantity SN into a the language model LM, the processor 12 of the multimedia generation apparatus 1 generates a plurality of narration texts NT, a plurality of dialogue texts CT, a plurality of scene descriptions SD, and a music description MD.

In some embodiments, the language model LM may be implemented by large language models (LLM), such as, ChatGPT, DeepSeek-R1, etc.

Next, the processor 12 of the multimedia generation apparatus1 inputs the narration texts NT and the dialogue texts CT into a text-to-speech model TS to output a plurality of narration audios NA and a plurality of dialogue audios CA.

In some embodiments, the text-to-speech model TS may be implemented by models, such as gTTS, Azure Cognitive Services, Amazon Polly and/or other models with similar functions.

On the other hand, if subtitles need to be further generated, the processor 12 of the multimedia generation apparatus 1 further performs a subtitle generation CG operation based on the narration texts NT and the dialogue texts CT to correspondingly generate a plurality of subtitles CP.

In addition, the processor 12 of the multimedia generation apparatus 1 inputs the scene descriptions SD into a text-to-image model TI to output a plurality of 360-degree images SI.

In some embodiments, the processor 12 of the multimedia generation apparatus 1 generates at least one 360-degree image SI for each scene based on the scene descriptions SD as material for subsequent video generation.

In some embodiments, the text-to-image model TI may be implemented by, for example, blockadelabs and/or other models with similar functions.

Furthermore, after generating the 360-degree images SI, the processor 12 of the multimedia generation apparatus 1 inputs the 360-degree images SI into an image-to-video model IV to output a plurality of 360-degree videos SV.

In some embodiments, the image-to-video model IV may be implemented by, for example, Pika AI and/or other models with similar functions.

In some embodiments, for each scene, when generating the corresponding 360-degree video SV, the multimedia generation apparatus 1 refers to the duration of the corresponding dialogue audio CA and accordingly determines the duration of the corresponding 360-degree video SV.

Specifically, the operation of the processor 12 to generate the 360-degree videos further includes: calculating a first scene duration of a first scene description in the scene descriptions based on at least one first dialogue audio in the dialogue audios, wherein the at least one first dialogue audio corresponds to the first scene description, and generating a first 360-degree video based on the first scene duration and a first 360-degree image in the 360-degree images, wherein the first 360-degree image and the first 360-degree video correspond to the first scene description, and the duration of the first 360-degree video matches the first scene duration.

In the embodiment with narration, for each scene, the multimedia generation apparatus 1 refers to the duration of the corresponding dialogue audio CA and the duration of the corresponding narration audio NA and accordingly determines the duration of the corresponding 360-degree video SV.

Specifically, the operation of the processor 12 to generate the 360-degree videos further includes: calculating a first scene duration of a first scene description in the scene descriptions based on at least one first dialogue audio in the dialogue audios and at least one first narration audio in the narration audios, wherein the at least one first dialogue audio and the at least one first narration audio correspond to the first scene description, and generating a first 360-degree video based on the first scene duration and a first 360-degree image in the 360-degree images, wherein the first 360-degree image and the first 360-degree video correspond to the first scene description, and the duration of the first 360-degree video matches the first scene duration.

More specifically, in some embodiments, for each scene, the multimedia generation apparatus 1 sums the duration of the corresponding dialogue audio CA and/or the duration of the corresponding narration audio NA, and accordingly determines the duration of the corresponding 360-degree video SV. For example, a 2-second transition time may be added to the summed duration to determine the duration of the corresponding 360-degree video SV.

Specifically, the operation of the processor 12 to calculate the first scene duration further includes: summing the at least one duration of the at least one first dialogue audio to calculate the first scene duration.

Accordingly, the multimedia generation apparatus 1 may ensure that when the multimedia file MF is finally generated, audios and video of each scene may match each other.

In some embodiments, the multimedia generation apparatus1 instructs the image-to-video model IV to use the input 360-degree images SI as initial frames (i.e., the first frames) of the 360-degree videos SV. Accordingly, the multimedia generation apparatus 1 may ensure the relevance between the generated 360-degree videos SV and the 360-degree images SI.

Specifically, the operation of the processor 12 to generate the 360-degree videos further includes: inputting a first 360-degree image in the 360-degree images into an image-to-video model to output a first video segment, wherein an initial frame of the first video segment is the first 360-degree image, and generating one of the 360-degree videos based on the first video segment.

In some embodiments, due to the limitations of the image-to-video model IV, the image-to-video model IV may only generate a 360-degree video SV of a fixed duration (e.g., 3 seconds) based on each input 360-degree image SI. Accordingly, in order to generate a 360-degree video SV of a desired duration, the multimedia generation apparatus 1 utilizes the characteristics of the image-to-video model IV to generate a plurality of 360-degree video segments in a plurality of stages.

Specifically, the operation of the processor 12 to generate the 360-degree videos further includes: inputting the final frame of the first video segment into the image-to-video model to output a second video segment, wherein the initial frame of the second video segment is the final frame of the first video segment, and connecting the first video segment and the second video segment to generate one of the 360-degree videos.

More specifically, when the duration of the 360-degree video SV thus generated by the image-to-video model IV cannot meet the demand, the multimedia generation apparatus 1 utilizes the final frame (i.e., the last frame) of the obtained 360-degree video SV as the input of the image-to-video model IV to generate a subsequent 360-degree video SV.

Specifically, the first video segment corresponds to a first scene description in the scene descriptions, and the operation of the processor 12 to generate the 360-degree videos further includes: determining whether the duration of the first video segment meets a first scene duration of the first scene description, in response to the duration of the first video segment not meeting the first scene duration, utilizing an image-to-video model to generate a second video segment based on the first video segment, and generating a first 360-degree video corresponding to the first scene description based on the first video segment and the second video segment.

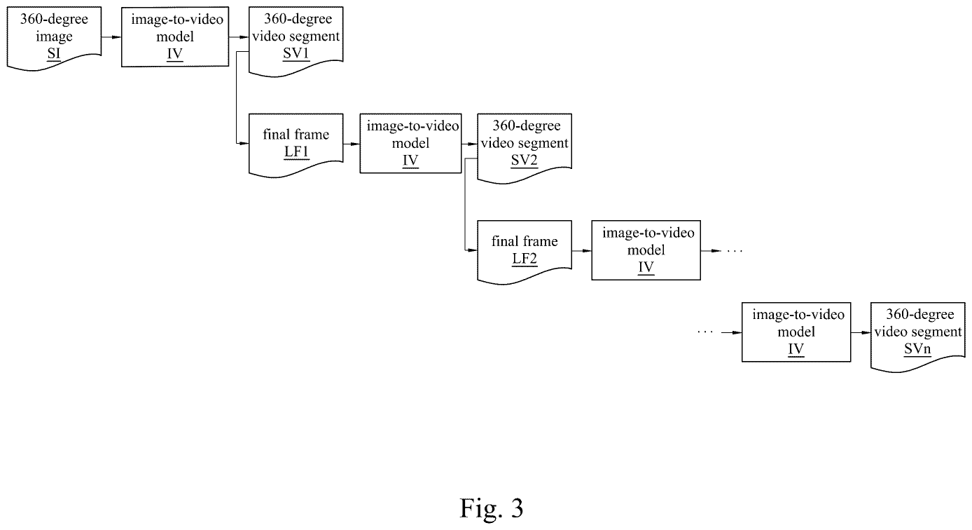

For details of generating a 360-degree video SV, please further refer to FIG. 3, which is a schematic diagram of generating a plurality of 360-degree video segments SV1~SVn according to some embodiments of the disclosure.

For example, if the intended output is an 11-second 360-degree video SV, the multimedia generation apparatus 1 first inputs a 360-degree image SI into the image-to-video model IV to generate a 3-second 360-degree video segment SV1, wherein the initial frame of the 360-degree video segment SV1 is the 360-degree image SI.

Next, the processor 12 of the multimedia generation apparatus 1 inputs the final frame LF1 of the 360-degree video segment SV1 into the image-to-video model IV to generate a 3-second 360-degree video segment SV2, wherein the initial frame of the 360-degree video segment SV2 is the final frame LF1.

Then, the similar operation is performed based on the final frame LF2 of the 360-degree video segment SV2. Finally, the multimedia generation apparatus 1 generates four 360-degree video segments SV1-SV4, totaling 12 seconds, wherein the 360-degree video segments SV1-SV4 may be sequentially concatenated to form a continuous 360-degree video SV.

The multimedia generation apparatus 1 removes a 1-second segment (e.g., removes the last 1 second) from the concatenated 360-degree video SV to obtain an 11-second 360-degree video SV.

On the other hand, please refer back to FIG. 2, the multimedia generation apparatus 1 inputs the music description MD into a text-to-audio model TA to output a background music BM.

In some embodiments, the text-to-audio model TA may be implemented by, for example, Amper Music, AIVA, Soundraw, Boomy, Mubert and/or other models with similar functions.

Finally, the multimedia generation apparatus 1 performs a combination CB operation on the narration audios NA, the dialogue audios CA, the subtitles CP, the 360-degree videos SV and the background music BM to generate the multimedia file MF, wherein the multimedia file MF is a 360-degree video having the above elements (i.e., background music, audio, subtitles, dynamic images, etc.).

In some embodiments, when generating the music description MD, the multimedia generation apparatus 1 first utilizes the language model LM to generate the scene descriptions SD, and then generates the music description MD based on the scene descriptions SD.

Specifically, the operation of the processor 12 to generate the music description further includes: based on the scene descriptions, utilizing a second language model to generate a plurality of scene music descriptions corresponding to the scene descriptions, and severing the scene music descriptions as the music description.

For example, after obtaining the scene descriptions SD, the multimedia generation apparatus 1 inputs a prompt text in Table 2 below into a language model to generate the music description MD.

TABLE 2
Please help me design a suitable background music based on the following
scene description.
You do not need to generate the background music directly, just provide
a music scene description suitable for a text-to-music model.
My scene description is: {scene_text}
When you respond, please follow the format below and be sure to use
brackets: [music_description]:

The multimedia generation apparatus 1 replaces {scene_text} with a scene descriptions SD and inputs the prompt text to the language model. Accordingly, the language model generates the music description MD corresponding to the scene descriptions SD.

It should be noted that the multimedia generation apparatus 1 may select a language model for generating the music description MD according to the demand. The multimedia generation apparatus 1 may also utilize the language model LM for generating the scene descriptions SD to generate the music description MD, or may utilize other language models.

In summary, the multimedia generation apparatus 1 of the disclosure may expand the prompt text to generate the multimedia file including the 360-degree videos. In addition, by combining different models, the multimedia generation apparatus 1 may generate elements such as background music, subtitles, dialogue, narration, etc., and incorporate the elements into the multimedia file. Furthermore, the media generation apparatus 1 also takes into account the attributes of the elements (e.g., duration) to ensure that these elements are coordinated with one another.

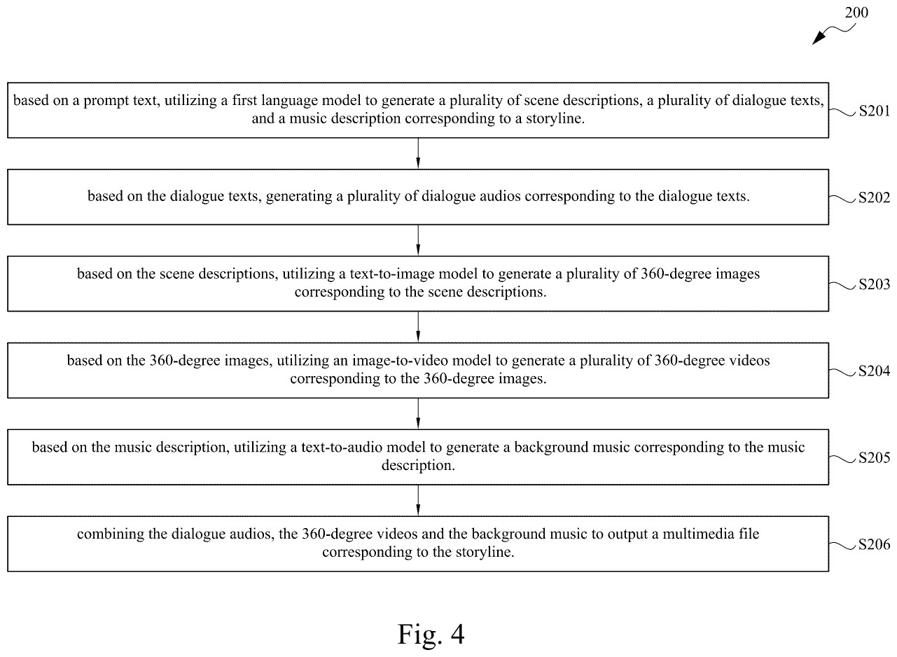

Please refer to FIG. 4, which is a flow chart illustrates a multimedia generation method 200 according to a second embodiment of the disclosure. The multimedia generation method 200 includes steps S201 to S206. The multimedia generation method 200 is configured to generate a multimedia file including 360-degree videos. The multimedia generation method 200 may be executed by an electronic device (e.g., the multimedia generation apparatus 1 in the first embodiment).

First, in step S201, the electronic device utilizes a first language model to generate a plurality of scene descriptions, a plurality of dialogue texts, and a music description corresponding to a storyline based on a prompt text.

Next, in step S202, the electronic device generates a plurality of dialogue audios corresponding to the dialogue texts based on the dialogue texts.

Next, in step S203, the electronic device utilizes a text-to-image model to generate a plurality of 360-degree images corresponding to the scene descriptions based on the scene descriptions.

Next, in step S204, the electronic device utilizes an image-to-video model to generate a plurality of 360-degree videos corresponding to the 360-degree images based on the 360-degree images.

Next, in step S205, the electronic device utilizes a text-to-audio model to generate a background music corresponding to the music description based on the music description.

Finally, in step S206, the electronic device combines the dialogue audios, the 360-degree videos, and the background music to output a multimedia file corresponding to the storyline.

In some embodiments, step S201 further includes the electronic device inputting the prompt text and a scene quantity into a language model to output the scene descriptions, wherein the number of scene descriptions matches the scene quantity.

In some embodiments, step S201 further includes the electronic device utilizing a second language model to generate a plurality of scene music descriptions corresponding to the scene descriptions based on the scene descriptions, and the electronic device serving the scene music descriptions as the music description.

In some embodiments, step S204 further includes the electronic device calculating a first scene duration of a first scene description in the scene descriptions based on at least one first dialogue audio in the dialogue audios, wherein the at least one first dialogue audio corresponds to the first scene description, and the electronic device generating a first 360-degree video based on the first scene duration and a first 360-degree image in the 360-degree images, wherein the first 360-degree image and the first 360-degree video correspond to the first scene description and the duration of the first 360-degree video matches the first scene duration.

In some embodiments, the step of calculating the first scene duration further includes the electronic device summing the at least one duration of the at least one first dialogue audio to calculate the first scene duration.

In some embodiments, step S204 further includes the electronic device inputting the first 360-degree image in the 360-degree images into the image-to-video model to output a first video segment, wherein an initial frame of the first video segment is the first 360-degree image, and the electronic device generating one of the 360-degree videos based on the first video segment.

In some embodiments, step S204 further includes the electronic device inputting a final frame of the first video segment into the image-to-video model to output a second video segment, wherein the initial frame of the second video segment is the final frame of the first video segment, and the electronic device connecting the first video segment and the second video segment to generate one of the 360-degree videos.

In some embodiments, the first video segment corresponds to the first scene description in the scene descriptions, and step S204 further includes the electronic device determining whether a duration of the first video segment meets the first scene duration of the first scene description, in response to the duration of the first video segment not meeting the first scene duration, the electronic device utilizing the image-to-video model to generate the second video segment based on the first video segment, and the electronic device generating the first 360-degree video corresponding to the first scene description based on the first video segment and the second video segment.

In some embodiments, the multimedia generation method 200 further includes the electronic device utilizing the first language model to generate a plurality of narration texts corresponding to the storyline based on the prompt text, the electronic device generating a plurality of narration audios corresponding to the narration texts based on the narration texts, and the electronic device combining the dialogue audios, the 360-degree videos, the background music, and the narration audios to output the multimedia file.

In some embodiments, step S204 further includes the electronic device calculating the first scene duration of the first scene description in the scene descriptions based on the at least one first dialogue audio in the dialogue audios and at least one first narration audio in the narration audios, wherein the at least one first dialogue audio and the at least one first narration audio correspond to the first scene description, and the electronic device generating the first 360-degree video based on the first scene duration and the first 360-degree image in the 360-degree images, wherein the first 360-degree image and the first 360-degree video correspond to the first scene description and the duration of the first 360-degree video matches the first scene duration.

In summary, the multimedia generation method 200 of the disclosure may expand the prompt text to generate the multimedia file including the 360-degree videos. In addition, by combining different models, the multimedia generation method 200 may generate elements such as background music, subtitles, dialogue, narration, etc., and incorporate these elements into the multimedia file. Furthermore, the media generation method 200 also takes into account the attributes of the elements (e.g., duration) to ensure that these elements are coordinated with one another.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. A multimedia generation apparatus, comprising:
a storage; and
a processor that is electrically connected to the storage, and that is configured to perform operations of:
based on a prompt text, utilizing a first language model to generate a plurality of scene descriptions, a plurality of dialogue texts, and a music description that correspond to a storyline,
based on the dialogue texts, generating a plurality of dialogue audios that correspond to the dialogue texts,
based on the scene descriptions, utilizing a text-to-image model to generate a plurality of 360-degree images that correspond to the scene descriptions,
based on the 360-degree images, utilizing an image-to-video model to generate a plurality of 360-degree videos that correspond to the 360-degree images,
based on the music description, utilizing a text-to-audio model to generate a background music that corresponds to the music description, and
combining the dialogue audios, the 360-degree videos, and the background music to store a multimedia file that corresponds to the storyline in the storage.

2. The multimedia generation apparatus of claim 1, wherein the operation of generating the scene descriptions comprises:
inputting the prompt text and a scene quantity into the first language model to output the scene descriptions, wherein a number of the scene descriptions matches the scene quantity.

3. The multimedia generation apparatus of claim 1, wherein the operation of generating the music description comprises:
based on the scene descriptions, utilizing a second language model to generate a plurality of scene music descriptions that correspond to the scene descriptions, and
serving the scene music descriptions as the music description.

4. The multimedia generation apparatus of claim 1, wherein the operation of generating the 360-degree videos comprises:
based on at least one first dialogue audio in the dialogue audios, calculating a first scene duration of a first scene description in the scene descriptions, wherein the at least one first dialogue audio corresponds to the first scene description, and
based on the first scene duration and a first 360-degree image in the 360-degree images, generating a first 360-degree video, wherein the first 360-degree image and the first 360-degree video correspond to the first scene description and a duration of the first 360-degree video matches the first scene duration.

5. The multimedia generation apparatus of claim 4, wherein the operation of calculating the first scene duration comprises:
summing at least one duration of the at least one first dialogue audio to calculate the first scene duration.

6. The multimedia generation apparatus of claim 1, wherein the operation of generating the 360-degree videos comprises:
inputting a first 360-degree image in the 360-degree images into the image-to-video model to output a first video segment, wherein an initial frame of the first video segment is the first 360-degree image, and
based on the first video segment, generating one of the 360-degree videos.

7. The multimedia generation apparatus of claim 6, wherein the operation of generating the 360-degree videos further comprises:
inputting a final frame of the first video segment into the image-to-video model to output a second video segment, wherein an initial frame of the second video segment is the final frame of the first video segment, and
connecting the first video segment and the second video segment to output one of the 360-degree videos.

8. The multimedia generation apparatus of claim 6, wherein the first video segment corresponds to a first scene description of the scene descriptions, and the operation of generating the 360-degree videos further comprises:
determining whether a duration of the first video segment meets a first scene duration of the first scene description,
in response to the duration of the first video segment not meeting the first scene duration, based on the first video segment, utilizing the image-to-video model to generate a second video segment, and
based on the first video segment and the second video segment, generating a first 360-degree video corresponding to the first scene description.

9. The multimedia generation apparatus of claim 1, wherein the processor is further configured to perform operations of:
based on the prompt text, utilizing the first language model to generate a plurality of narration texts corresponding to the storyline,
based on the narration texts, generating a plurality of narration audios corresponding to the narration texts, and
combining the dialogue audios, the 360-degree videos, the background music, and the narration audios to output the multimedia file.

10. The multimedia generation apparatus of claim 9, wherein the operation of generating the 360-degree videos comprising:
based on at least one first dialogue audio of the dialogue audios and at least one first narration audio of the narration audios, calculating a first scene duration of a first scene description of the scene descriptions, wherein the at least one first dialogue audio and the at least one first narration audio correspond to the first scene description, and
based on the first scene duration and a first 360-degree image of the 360-degree images, generating a first 360-degree video, wherein the first 360-degree image and the first 360-degree video correspond to the first scene description and a duration of the first 360-degree video matches to the first scene duration.

11. A multimedia generation method, applied to an electronic device and comprising steps of:
based on a prompt text, utilizing a first language model to generate a plurality of scene descriptions, a plurality of dialogue texts, and a music description that correspond to a storyline,
based on the dialogue texts, generating a plurality of dialogue audios that correspond to the dialogue texts,
based on the scene descriptions, utilizing a text-to-image model to generate a plurality of 360-degree images that correspond to the scene descriptions,
based on the 360-degree images, utilizing an image-to-video model to generate a plurality of 360-degree videos that correspond to the 360-degree images,
based on the music description, utilizing a text-to-audio model to generate a background music that corresponds to the music description, and
combining the dialogue audios, the 360-degree videos, and the background music to output a multimedia file that corresponds to the storyline.

12. The multimedia generation method of claim 11, wherein the step of generating the scene descriptions comprises:
inputting the prompt text and a scene quantity into a language model to output the scene descriptions, wherein a number of the scene descriptions matches the scene quantity.

13. The multimedia generation method of claim 11, wherein the step of generating the music description comprises:
based on the scene descriptions, utilizing a second language model to generate a plurality of scene music descriptions that correspond to the scene descriptions, and
serving the scene music descriptions as the music description.

14. The multimedia generation method of claim 11, wherein the step of generating the 360-degree videos comprises:
based on at least one first dialogue audio in the dialogue audios, calculating a first scene duration of a first scene description in the scene descriptions, wherein the at least one first dialogue audio corresponds to the first scene description, and
based on the first scene duration and a first 360-degree image in the 360-degree images, generating a first 360-degree video, wherein the first 360-degree image and the first 360-degree video correspond to the first scene description and a duration of the first 360-degree video matches the first scene duration.

15. The multimedia generation method of claim 14, wherein the step of calculating the first scene duration comprises:
summing at least one duration of the at least one first dialogue audio to calculate the first scene duration.

16. The multimedia generation method of claim 11, wherein the step of generating the 360-degree videos comprises:
inputting a first 360-degree image in the 360-degree images into the image-to-video model to output a first video segment, wherein an initial frame of the first video segment is the first 360-degree image, and
based on the first video segment, generating one of the 360-degree videos.

17. The multimedia generation method of claim 16, wherein the step of generating the 360-degree videos further comprises:
inputting a final frame of the first video segment into the image-to-video model to output a second video segment, wherein an initial frame of the second video segment is the final frame of the first video segment, and
connecting the first video segment and the second video segment to output one of the 360-degree videos.

18. The multimedia generation method of claim 16, wherein the first video segment corresponds to a first scene description of the scene descriptions, and the step of generating the 360-degree videos further comprises:
determining whether a duration of the first video segment meets a first scene duration of the first scene description,
in response to the duration of the first video segment not meeting the first scene duration, based on the first video segment, utilizing the image-to-video model to generate a second video segment, and
based on the first video segment and the second video segment, generating a first 360-degree video corresponding to the first scene description.

19. The multimedia generation method of claim 11, further comprising steps of:
based on the prompt text, utilizing the first language model to generate a plurality of narration texts corresponding to the storyline,
based on the narration texts, generating a plurality of narration audios corresponding to the narration texts, and
combining the dialogue audios, the 360-degree videos, the background music, and the narration audios to output the multimedia file.

20. The multimedia generation method of claim 19, wherein the step of generating the 360-degree videos comprising:
based on at least one first dialogue audio of the dialogue audios and at least one first narration audio of the narration audios, calculating a first scene duration of a first scene description of the scene descriptions, wherein the at least one first dialogue audio and the at least one first narration audio correspond to the first scene description, and
based on the first scene duration and a first 360-degree image of the 360-degree images, generating a first 360-degree video, wherein the first 360-degree image and the first 360-degree video correspond to the first scene description and a duration of the first 360-degree video matches to the first scene duration.
